(19) United States
(12) Patent Application Publication
(10) Pub. No.: US 2012/0205354 A1
(43) Pub. Date: Aug. 16, 2012

(54) REDUCING DROSS WELDING PHENOMENON DURING IRRADIATION ENGRAVING OF A METAL SHEET

(75) Inventors: Takahiko Kudoh, Beppu-shi (JP); Kenji Masumoto, Hayami-gun (JP)

(73) Assignee: TEXAS INSTRUMENTS INCORPORATED, Dallas, TX (US)

(21) Appl. No.: 13/026,376

(22) Filed: Feb. 14, 2011

(51) Int. Cl. B23K 26/00

(52) U.S. Cl. 219/121.69

(57) ABSTRACT

A groove is formed in a metal sheet by performing an irradiation engraving operation on a first surface area of the metal sheet. The irradiation engraving operation displaces metal particles from the first surface area onto a second surface area of the metal sheet. The environment of the irradiation engraving operation is controlled to reduce the number of displaced metal particles that would otherwise weld to the second surface area.

### FIELD OF THE INVENTION

The invention relates generally to irradiation engraving of a metal sheet and, more particularly, to reducing a dross welding phenomenon during the engraving.

### BACKGROUND OF THE INVENTION

In conventional IC manufacturing, recesses or grooves may be provided at selected locations in the surface of the lead frame in order to increase the contact area between the lead frame and the encapsulation (molding) material subsequently deposited on the lead frame. The increased contact area provides, for example, improved adhesion between the lead frame and the molding material. The recesses are sometimes formed by applying radiation to (i.e., irradiating) the lead frame at the locations selected for the recesses. For example, the locations may be irradiated with a laser. U.S. Patent Application Publication No. US 2010-0283135 (incorporated herein by reference) describes conventional examples of forming recesses or grooves in IC lead frames. The process of forming such recesses or grooves is also referred to herein as grooving or engraving.

When engraving the surface of the lead frame sheet metal using radiation such as a laser beam, a portion of the metal is melted and displaced to form the groove. This displaced metal piles up on the metal surface adjacent the groove in the form of metal particles. This accumulation of excess metal particles, or dross, should be removed so that it does not interfere with wire bonding or cause unwanted accumulation of a mold flash remnant after encapsulation. A smooth metal surface without accumulated dross is therefore desired.

Conventional techniques avoid dross accumulation by aiming an air jet at the groove to scatter dross particles away from the metal surface, and/or by applying vacuum suction to remove the dross particles. However, the present work has recognized that, because the displaced metal has been melted by irradiation, the dross includes molten metal particles that form a welding bond with the lead frame surface adjacent the grooves, making it difficult for conventional air jet and vacuum suction techniques to removing the welded particles from the lead frame surface.

It is therefore desirable to provide techniques that reduce and/or prevent the aforementioned dross welding phenomenon.

### BRIEF DESCRIPTION OF THE DRAWINGS

FIG. 1 diagrammatically illustrates an apparatus for engraving a metal sheet according to exemplary embodiments of the present work.

FIGS. 2 and 3 are side and plan views, respectively, that diagrammatically illustrate grooves produced and metal particles displaced by an irradiation engraving operation according to exemplary embodiments of the present work.

FIG. 4 illustrates operations performed according to exemplary embodiments of the present work.

### DETAILED DESCRIPTION

The present work provides techniques for lowering the temperature of the dross particles before they reach the metal surface adjacent the groove, thereby reducing and/or preventing the dross welding phenomenon, and permitting removal of the dross by techniques such as conventional air jets and/or vacuum suction.

Exemplary embodiments submerge the metal in a liquid during the irradiation engraving operation. Because the liquid is capable of effectively transferring heat away from the dross particles as they form, the particles are held at a lower temperature than in conventional irradiation engraving. This prevents or significantly reduces the dross welding phenomenon. Some embodiments immerse the metal in a flowing liquid, which aids in clearing away the dross. Some embodiments use conventional air jets and/or vacuum suction to clear away the dross after removing the metal from the liquid. Various embodiments use various combinations of flowing liquid, air jets and vacuum suction to clear the dross. The cooling effect of the liquid also helps protect the metal from irradiation damage that could otherwise impede subsequent wire bonding and soldering.

The liquid attenuates the power of the irradiation source, so the source applies less power to the metal surface than it would without the liquid immersion technique. Various embodiments match the liquid with the desired power delivery, for example, either selecting the liquid based on the power of an available source, or selecting the source power based on the attenuation characteristic of a selected liquid. Suitable combinations of irradiation power and immersion liquid are readily determined by empirical observations of various combinations. Various embodiments use various immersion liquids, for example, water, fluorinated wafer, and mineral oil of various specific weights.

In various embodiments, the thickness of the lead frame metal ranges between about 125 μm and about 200 μm. In some embodiments, the thickness of the lead frame metal is reduced by conventional mechanical processing to achieve a desired thickness prior to the engraving operation. In various embodiments, the grooves have a depth that ranges from 15% to 30% of the lead frame thickness, and a width that ranges from 0.1 mm to 0.25 mm. In some embodiments, the grooves have a straight trench configuration. In various embodiments, the grooves have various shapes, depths, and sizes. Engraving lead frames according to the aforementioned example dimensions and shapes is known in the art.

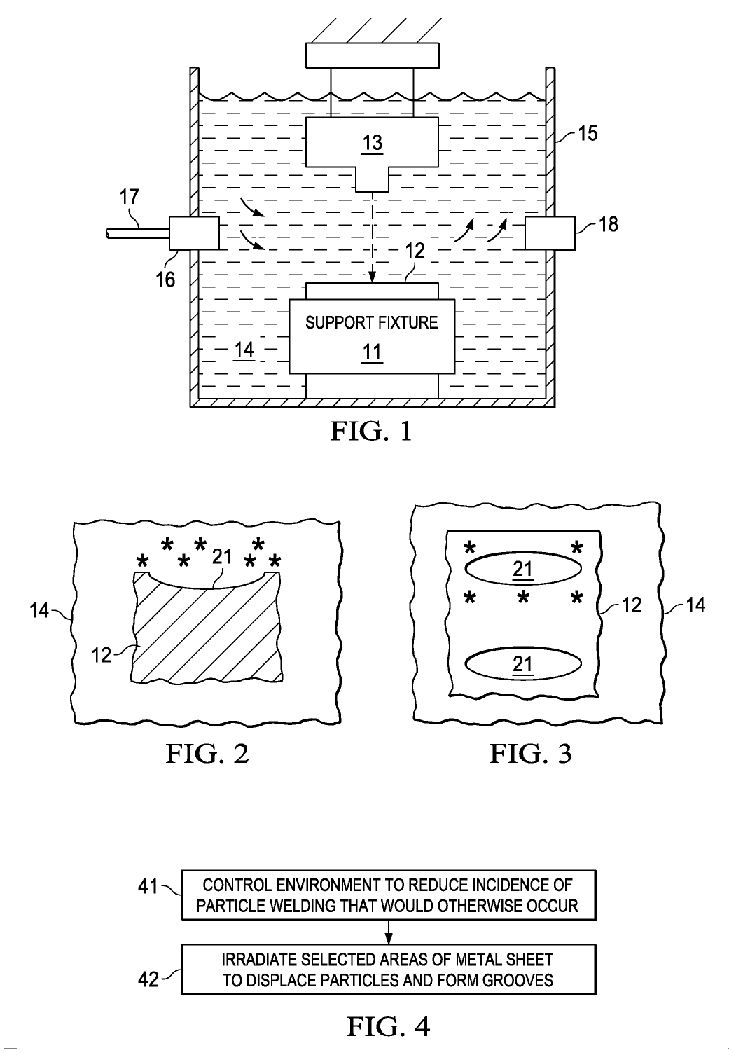

FIG. 1 diagrammatically illustrates an apparatus for engraving a metal sheet with grooves according to exemplary embodiments of the present work. A metal sheet 12 is mounted on an engraving support fixture 11, and is thereby positioned for irradiation by an irradiation source 13, a laser in some embodiments. In various embodiments, the metal is an alloy of Cu or Fe, or a pre-plated metal. Engraving arrangements of this type are generally known in the art, but perform the irradiation engraving operation in an environment of ambient air.

As shown in FIG. 1, the present work provides an environment controller to control the environment in which the irradiation engraving operation occurs. For example, in some embodiments, the conventional engraving arrangement 11-13 is provided within a tank 15 filled with a liquid 14. The engraving arrangement 11-13 is thus immersed in the liquid 14. The heat transfer characteristics of the liquid 14 reduce the temperature of the metal particles displaced from the metal sheet 12 as the applied irradiation forms grooves in the metal sheet. The temperature of the particles thus decreases between the time they are displaced from the grooved areas and the time they engage the surface of the metal sheet around the grooved areas. The liquid heat transfer characteristics also help prevent damage to the metal as mentioned above. FIG. 2 diagrammatically illustrates (in side sectional view) an example of particles being displaced during the irradiation engraving operation, and FIG. 3 diagrammatically illustrates (in plan view) an example of the displaced particles deposited at locations on the surface of the metal sheet adjacent one of the grooves 21.

Because the deposited particles shown in FIG. 3 have a lower temperature (due to heat transfer by the liquid 14) than they would otherwise have in operation of the conventional engraving arrangement, the aforementioned particle welding phenomenon is reduced significantly as compared to operation of the conventional arrangement. The particle welding phenomenon may even be eliminated completely in many instances.

Referring again to FIG. 1, some embodiments of the environment controller provide a conventional liquid impeller 16 connected to a liquid supply source 17. The impeller 16 produces a liquid flow within the tank 15, from the impeller 16 to a liquid exhaust port 18. The liquid flow, indicated generally by the arrows between the impeller 16 and the exhaust port 18, aids in clearing away the metal particles deposited adjacent the grooves 21 (see also FIGS. 2 and 3), as mentioned above. Various embodiments use various techniques to produce flowing liquid.

FIG. 4 illustrates operations performed according to exemplary embodiments of the present work. As shown at 41, the environment of the irradiation engraving operation is controlled to reduce the incidence of particle welding that would otherwise occur in conventional irradiation engraving operations. This is accomplished in some embodiments by immersing the engraving arrangement in a liquid (e.g., liquid 14 shown in the tank 15 of FIG. 1), and thereby lowering the temperature of the displaced metal particles before they are deposited on the surface of the metal sheet, as described above with respect to the examples of FIGS. 1-3. The irradiation engraving operation is shown at 42. With the environment controlled as shown at 41, selected areas of the metal sheet are irradiated at 42 to displace metal particles and form grooves in the selected areas.

In some embodiments, a sheet of transparent material such as glass is supported within the tank 15, interposed between the liquid 14 and the irradiation source 13. The radiation from the source 13 passes through the transparent sheet to perform the irradiation engraving. In flowing liquid embodiments, this arrangement accommodates a strong and stable flow of liquid.

Various embodiments produce grooves of various depths relative to the lead frame thickness, and grooves of various depths may be produced for any given embodiment. Any desired groove depth may be produced, including a depth equal to the thickness of the lead frame. Grooves of this latter depth thus constitute through-openings extending completely through the lead frame. As such, the term “groove” as used herein is intended to refer to a groove of any depth, including a through-opening. In some embodiments, the through-openings are significantly larger in size (i.e., area) than the other grooves. In some embodiments, a sequence of repeated irradiations is used to produce a groove of any desired depth. For example, a sequence of four irradiations may be applied to produce grooves twice as deep as those produced when a sequence of two irradiations is applied.

In some embodiments, the irradiation source 13 is selected based on the target metal. For example, some embodiments use a Green laser or UV (ultraviolet) laser as the radiation source 13 for a Cu alloy metal, and some embodiments use a CO₂ laser as the irradiation source for a Fe alloy metal. In some embodiments, the irradiation source 13 has a wavelength in the microwave range.

Although the present work is described above, for expository purposes, with respect to engraving lead frames for integrated circuits, the engraving techniques of the present work are useful in other contexts, for example, in other applications where metal sheets are engraved by irradiation.

Although exemplary embodiments of the invention have been described above in detail, this does not limit the scope of the invention, which can be practiced in a variety of embodiments.

What is claimed is:

1. A method of engraving a metal sheet, comprising:
performing on a first surface area of the metal sheet an irradiation engraving operation that displaces metal particles from said first surface area onto a second surface area of the metal sheet; and
controlling an environment in which said irradiation engraving operation is performed to reduce a number of the displaced metal particles that would otherwise weld to said second surface area.

2. The method of claim 1, wherein said controlling includes providing said environment with a heat transfer characteristic effective to lower a temperature of the displaced metal particles, after displacement form said first surface area and before engagement with said second surface area, sufficiently to prevent at least some of the displaced metal particles from experiencing welding that would otherwise occur on said second surface area.

3. The method of claim 2, wherein said providing includes maintaining the metal sheet immersed in a liquid during said displacement of said metal particles onto said second surface area.

4. The method of claim 3, wherein the liquid is a flowing liquid.

5. The method of claim 3, wherein the liquid is one of water, fluorinated wafer, and mineral oil.

6. The method of claim 1, provided in a process for fabricating from the metal sheet a lead frame for an integrated circuit.

7. The method of claim 6, wherein the irradiation engraving operation produces in the metal sheet a groove adapted to enhance adhesion between the lead frame and a material that encapsulates the integrated circuit.

8. The method of claim 1, including performing said irradiation engraving operation and said controlling with respect to a plurality of sets of said first and second surface areas.

9. The method of claim 1, wherein said irradiation engraving operation includes irradiating the metal sheet with a laser.

10. The method of claim 1, wherein said second surface area is adjacent said first surface area.

11. An apparatus for engraving a metal sheet, comprising:
means for performing on a first surface area of the metal sheet an irradiation engraving operation that displaces metal particles from said first surface area onto a second surface area of the metal sheet; and
means for controlling an environment in which said irradiation engraving operation is performed to reduce a number of the displaced metal particles that would otherwise weld to said second surface area.

12. The apparatus of claim 11, wherein said means for controlling includes means for providing said environment with a heat transfer characteristic effective to lower a temperature of the displaced metal particles, after displacement form said first surface area and before engagement with said second surface area, sufficiently to prevent at least some of the displaced metal particles from experiencing welding that would otherwise occur on said second surface area

13. The apparatus of claim 12, wherein said means for providing includes means for maintaining the metal sheet immersed in a liquid during said displacement of said metal particles onto said second surface area.

14. The apparatus of claim 13, wherein the liquid is a flowing liquid.

15. An apparatus engraving a metal sheet, comprising:
an irradiation source;
a support for positioning the metal sheet relative to said irradiation source to permit said irradiation source to perform on a first surface area of the metal sheet an irradiation engraving operation that displaces metal particles from said first surface area onto a second surface area of the metal sheet; and
an environment controller for controlling an environment in which said irradiation engraving operation is performed to reduce a number of the displaced metal particles that would otherwise weld to said second surface area.

16. The apparatus of claim 15, wherein said environment controller is adapted to provide said environment with a heat transfer characteristic effective to lower a temperature of the displaced metal particles, after displacement form said first surface area and before engagement with said second surface area, sufficiently to prevent at least some of the displaced metal particles from experiencing welding that would otherwise occur on said second surface area.

17. The apparatus of claim 16, wherein said environment controller is configured to maintain the metal sheet immersed in a liquid during said displacement of said metal particles onto said second surface area.

18. The apparatus of claim 17, wherein the liquid is a flowing liquid.

19. The apparatus of claim 15, wherein said irradiation source includes a laser.

20. The apparatus of claim 15, wherein the irradiation engraving operation produces in the metal sheet a groove adapted to enhance adhesion between the metal sheet and a material applied to encapsulate the metal sheet.
